(19) United States
(12) Patent Application Publication
(10) Pub. No.: US 2026/0068025 A1
(43) Pub. Date: Mar. 5, 2026

(54) METHOD AND DEVICE FOR RECOGNIZING A PROCESS STATE OF A PLASMA ARC METHOD

(71) Applicant: KJELLBERG-STIFTUNG, Finsterwalde (DE)

(72) Inventors: Marcel TEMPELHAGEN, Finsterwalde (DE); Volker KRINK, Finsterwalde (DE); René NOGOWSKI, Finsterwalde (DE); Vadim GÜNTHER, Finsterwalde (DE)

(21) Appl. No.: 19/101,060

(22) PCT Filed: Aug. 4, 2023
(86) PCT No.: PCT/EP2023/071642

§ 371 Date: Feb. 4, 2025

(30) Foreign Application Priority Data
Aug. 5, 2022 (DE) 10 2022 208 184.6

(51) Int. Cl. H05H 1/34; H05H 1/00

(52) U.S. Cl. CPC H05H 1/3494; H05H 1/0081

(57) ABSTRACT

A method for recognizing a process state of a plasma arc method, in which a workpiece is processed by a plasma torch and measured values of a time curve of a physical variable of the plasma arc method are detected and a signal curve is determined from the measured values. A pattern recognition is performed on the signal curve by extracting at least one feature from the signal curve and classifying the feature, and the signal curve is assigned to a specific state of the plasma arc method according to the classification of the feature.

The present invention relates to a method and a device for recognizing a process state of a plasma arc method.

In plasma arc methods such as plasma cutting, events may occur that have a negative effect on the result to be achieved. This concerns, for example, the quality of a cut, damage to the plasma torch or the cutting material, in particular due to an unforeseen or unforeseeable failure or the use of wearing parts beyond a recommended operating time. To counteract this, the plasma arc method is monitored with the aim of being able to detect such events in good time and, if necessary, abort the process or change one or more process parameters. This not only serves to optimize the respective plasma arc method, but also to protect the plasma torch or workpiece used for this purpose.

Several approaches are known from the prior art. Typically, a single parameter such as an amplitude or a rate of change of an electrical voltage is determined and a corresponding measure is initiated if a threshold value is exceeded. For example, U.S. Pat. No. 5,750,957 A discloses a method in which a standard deviation of an electrical signal is monitored and used to assess the quality of the process.

However, the disadvantage of this approach is that the parameters used for quality control are often dependent on method parameters such as the speed of the plasma arc method and the material thickness of the workpiece, meaning that the threshold value to be determined requires knowledge of these cutting parameters and is difficult to generalize.

The penetration through the workpiece as a cutting material may also manifest itself in different signal curves for different material thicknesses, so that a pure comparison with a threshold value generally only provides inadequate results here. The same applies to wearing part failure, which causes different signal patterns that depend, among other things, on the cathode used.

The present invention therefore addresses the problem of proposing a method and a device which avoid the disadvantages mentioned, i.e.

with which process states, in particular faults, of a plasma arc method may be determined quickly and reliably.

According to the invention, this problem is solved by a method according to claim 1 and a device according to the coordinated claim. Advantageous embodiments and developments are described in the dependent claims.

In a method for recognizing a process state of a plasma arc method or plasma arc method, a workpiece is processed by a plasma torch and measured values of a time curve of a physical variable of the plasma arc method are detected. A signal curve is determined from the measured values and a pattern recognition is carried out on the signal curve. At least one feature is extracted here from the signal curve and is classified. Finally, depending on the classification of the feature, the signal curve is assigned to a specific state of the plasma arc method.

By recording the time curve of a physical variable associated with the plasma arc method, a (time) signal curve of this physical variable that is typical for the respective method is determined. By not just looking for an exceeded threshold value, which may also trigger false alarms due to strong noise, deviating process parameters, etc., but by using pattern recognition to look for similar patterns to already known process states, a more reliable statement about the process state is possible than with known methods. For this purpose, features are obtained from the signal sequences that may be assigned to a pattern to be detected and assigned to a common class (classification). The classification, i.e. the assignment to a specific state of the plasma arc method, allows a more reliable statement to be made about the state of the plasma arc method than with a pure threshold value analysis. The method may therefore be used in particular to monitor arc stability, detect the failure of wearing parts and stop operation in order to protect the plasma torch from irreparable damage. Furthermore, conditions for a reduction in cathode service life, such as burning of the arc over a hole after a piercing process or running over of a workpiece end, may be determined in order to subsequently take measures to maintain the cathode service life by influencing process parameters, such as lowering the plasma torch or reducing a cutting current or cutting gas pressure.

The signal curve may be available directly in the time domain or also in the frequency domain, for example by converting the time curve of the measured values into the frequency domain using a Fourier transformation.

It may be provided that the at least one physical variable is an electrical voltage, an electrical voltage drop and/or an electrical current. These variables are generally relevant for the plasma arc and may be reliably determined.

The at least one feature may be determined from amplitudes of the measured values and/or an amplitude spectrum, wherein the feature is preferably determined from a sum of the amplitude spectrum over at least one predetermined frequency range, particularly preferably at least two predetermined frequency ranges. Especially when using certain relevant frequency ranges of the amplitude spectrum, process states in which frequencies in these frequency ranges often occur may be determined with high accuracy. The term “signal curve” may therefore describe both the time curve of the measured values and an amplitude spectrum obtained therefrom.

However, it is also possible for the at least one feature to be determined from a parameterization of at least one or more portions or a parameterization of the entire signal curve. This enables fast and reliable detection in particular of process states, which may be detected by a change over time. Preferably, the feature is determined from a parameterization of one or more individual portions of the signal curve by forming a sequence of mean values and/or rates of change and/or regression values of a regression analysis.

The number of recorded measured values forming a signal curve may be at least 500 measured values, preferably 10,000 measured values, particularly preferably 15,000 measured values, in order to achieve sufficiently high accuracy and thus reliability of the method.

The time between two individual measured values, which form a signal curve, may be a maximum of 1 ms, preferably 0.05 ms, particularly preferably 0.03 ms, in order to be able to determine process states sufficiently quickly. The pattern recognition is typically performed in real time, i.e. within a maximum of 1.5 s, or is available in the form of a look-up table in which the results of the pattern recognition are calculated for any combination of features and are stored in a table.

The time for measuring and forming a signal curve may be a maximum of 1500 ms, preferably a maximum of 500 ms and particularly preferably a maximum of 350 ms in order to obtain information about the process state in real time. The measurement time is preferably longer than the time required to obtain the features or recognize the pattern.

To increase the reliability of the method, it is usually also intended to determine at least two features and use them to determine the process state, i.e. to extract at least two features from the signal curve and to classify said features. However, the number of features is typically smaller than the number of individual measured values.

Classification classes typically comprise at least one stable process state and/or at least one unstable process state. If the stable process state is present, the plasma arc method is continued unchanged, whereas if the unstable process state is present, the plasma arc method is preferably interrupted in order to avoid damage. The unstable process state may be caused by or indicate damaged or worn wearing parts in particular. Other states may also be classified that indicate faults such as an ejection of hafnium from the cathode or double arcs between the cathode and nozzle, but do not require any intervention in the process.

The plasma arc method is typically plasma cutting with a plasma cutting torch. In principle, however, all processes in which materials are processed using a plasma arc may be regarded as plasma arc methods. In this case, the classes may have, as process states, an idling, ignition of a pilot arc, burning of the pilot arc, piercing of the workpiece, penetration through the workpiece, cutting of the workpiece, running over a cut, running over a workpiece edge, presence of a damaged wearing part and/or presence of a worn wearing part or of a plurality of worn wearing parts. Alternatively or additionally, the consumption of a wearing part or, in particular, the classification into the classes of presence of a damaged wearing part, presence of a new wearing part, presence of a used wearing part and/or presence of a worn wearing part may be classified on the basis of the burn-back of the cathode (measured in millimeters) and/or on the basis of the burn-back in relation to a specified service life. In the first case, for example, a classification may be made according to the remaining length of the cathode, i.e. for example a length in the range 0 mm to 1 mm, a length in the range 1 mm to 1.8 mm and a remaining length greater than 1.8 mm. In relation to a maximum service life, which manifests itself in a maximum possible burn-back, a classification may also be made using percentages between 0 percent, i.e. no burn-back, and 100 percent, i.e. maximum burn-back and reaching the maximum service life.

Depending on the result of the classification, an optical, acoustic, electrical and/or electronic signal or a signal that may be evaluated optically, acoustically, electrically and/or electronically may be generated or output in order to stabilize or terminate the plasma arc method. The signal may also be a warning signal to prompt a person to intervene.

A device for recognizing a process state of a plasma arc method has a plasma torch which is set up to process a workpiece. The device also comprises a measured value recording device which is configured to record measured values of a time curve of a physical variable of the plasma arc method and to determine a signal curve from the measured values. In addition, an evaluation unit is part of the device and is set up to extract at least one feature from the signal curve and to classify said feature, and, depending on the classification of the feature, to assign the signal curve to a specific state of the plasma arc method.

The plasma torch typically has at least one electrode and one nozzle and is supplied with electrical energy from an electrical current source or an electrical voltage source, which may also be part of the device. The workpiece serves as a second electrode. In addition, a control unit may be provided that controls the current or voltage source, in particular also on the basis of signals received from the evaluation unit.

The device may also have an inductive component that is electrically connected in series with the plasma torch. In this case, the measured value recording device is also configured to measure an electrical current flowing through the inductive component or an electrical voltage drop across the inductive component. At least part of the electrical current that also flows through the electrode of the plasma torch usually flows through the inductive component.

The electrical voltage to be measured may be the electrical voltage between the electrode of the plasma torch and the workpiece, the electrical voltage between the electrode and the nozzle and/or the voltage drop across the inductive component, which is typically configured as a choke.

The electrical current to be measured may in particular be the electrical current that flows from the electrode to the nozzle and/or from the electrode to the workpiece.

The device described is typically set up for carrying out the method described, i.e. the method explained may be carried out with this device.

A computer program product comprises a computer program, having software means for carrying out the described method and/or for controlling the described device when the computer program is run in an automation system or computing unit.

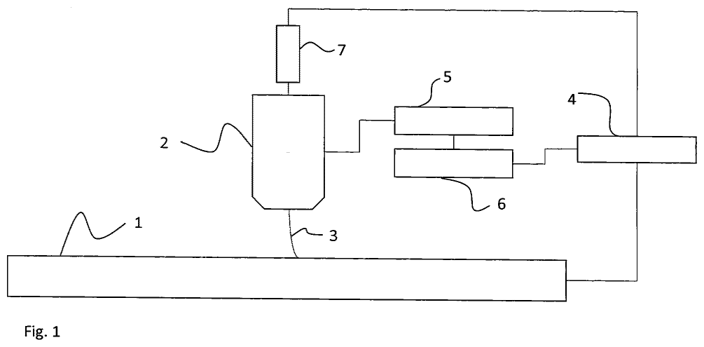

Exemplary embodiments of the invention are shown in the drawings and will be explained below with reference to FIGS. 1-11.

In the drawings:

FIG. 1 shows a schematic side view of a device for plasma arc processing;

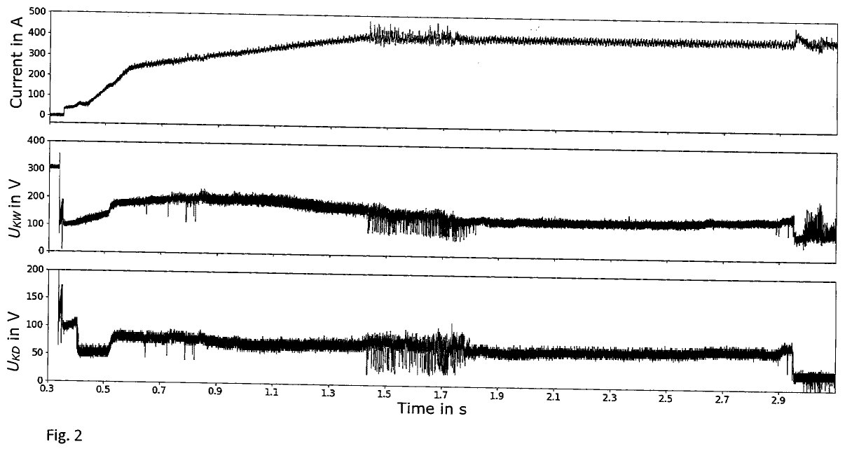

FIG. 2 shows a graph with measured values of physical variables recorded over a certain period of time;

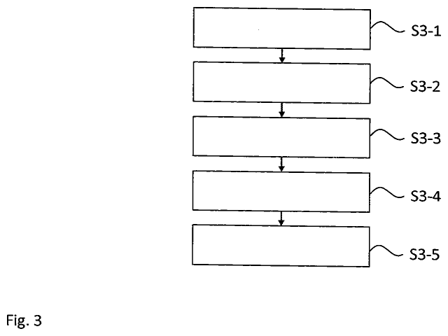

FIG. 3 shows a schematic method sequence of a pattern recognition;

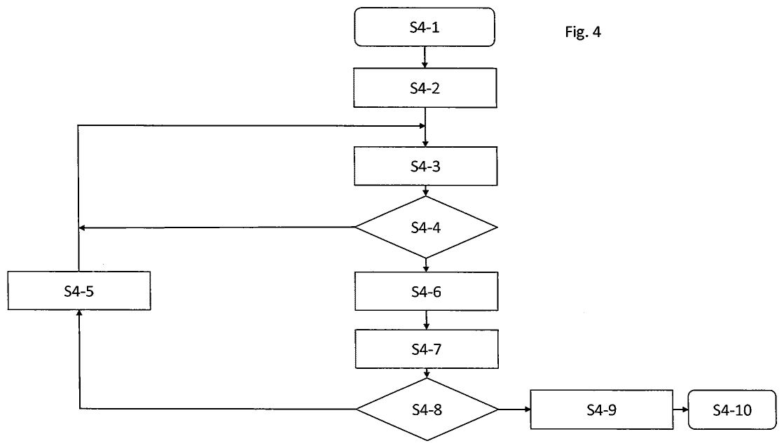

FIG. 4 shows a view of a detailed method sequence for pattern recognition corresponding to FIG. 3;

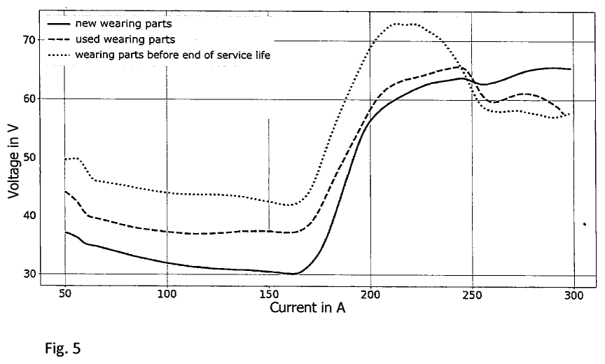

FIG. 5 shows a schematic representation of a signal curve consisting of voltage and current for determining the state of wearing parts;

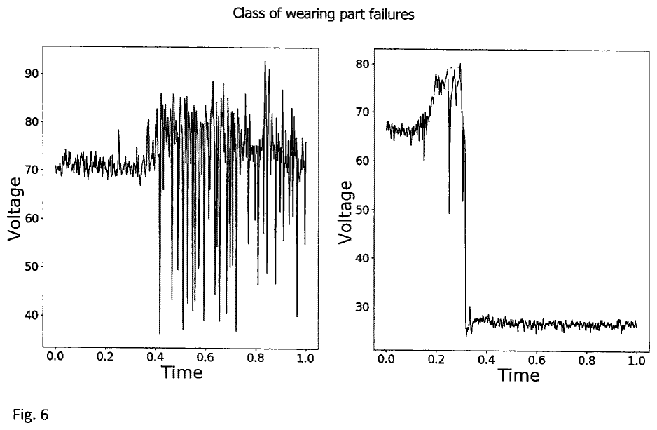

FIG. 6 shows a schematic representation of a signal curve in the event of a defective wearing part;

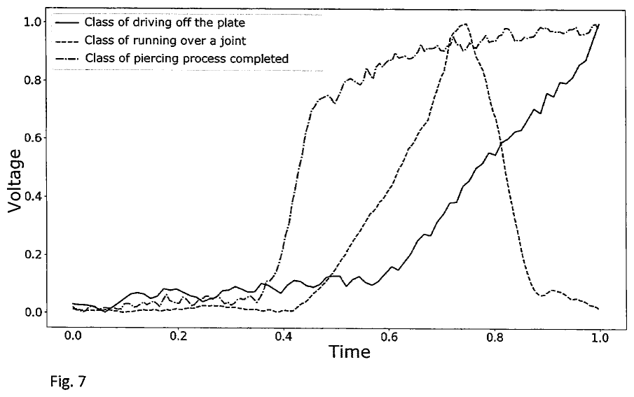

FIG. 7 shows a schematic representation of a signal curve corresponding to FIG. 6 when running over a joint or leaving a plate;

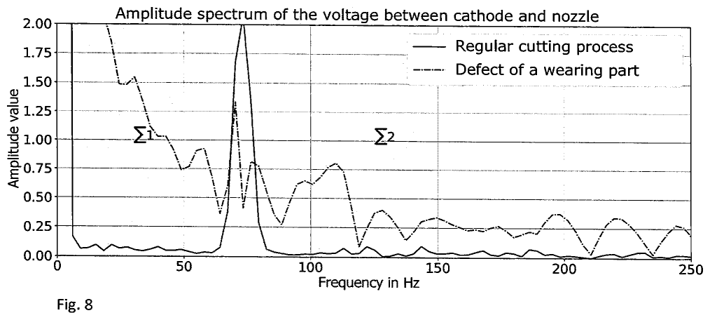

FIG. 8 shows a schematic representation of a summing of an amplitude spectrum;

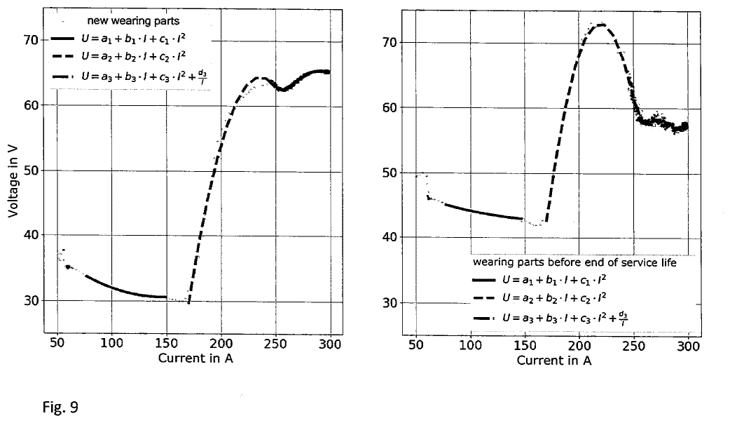

FIG. 9 shows a schematic graph for pattern recognition using parameterization;

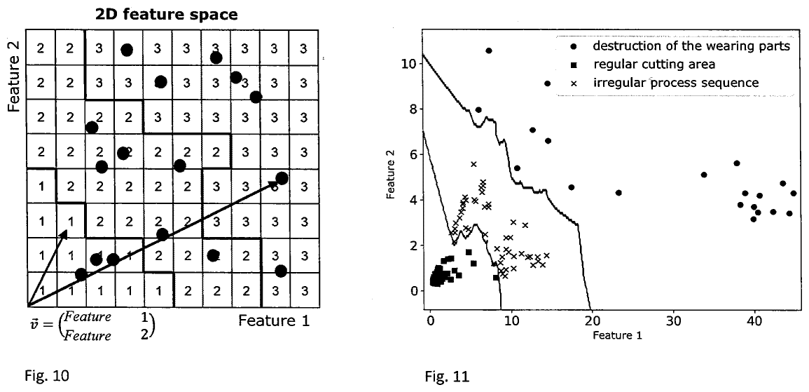

FIG. 10 shows a schematic representation of a feature space; and

FIG. 11 shows a real representation of a feature space.

FIG. 1 shows a schematic side view of a device for carrying out and monitoring a plasma arc method, in the exemplary embodiment shown plasma cutting. A plasma torch 2 or plasma cutting torch, which has a nozzle and an electrode (as well as other components such as coolant inlets and the like, which are known from the prior art and are therefore not listed here for reasons of clarity), is electrically connected to a power source 4 and emits a plasma arc 3 in order to cut a workpiece 1, which is also electrically connected to the power source 4. In the exemplary embodiment shown, a choke 7 is electrically connected in series with the plasma torch 2 as an inductive component, but in further embodiments the choke 7 may also be dispensed with. A measured value recording device 5 is used to record measured values of a time curve of a physical variable such as electrical current, electrical voltage or electrical voltage drop, in particular during the cutting process, and to evaluate said measured values in an evaluation unit 6.

The evaluation unit 6 is set up to carry out pattern recognition on this signal curve from the measured values obtained and a signal curve determined by the measured value recording device 5. At least one feature, but typically two features, are extracted from the signal curve by the evaluation unit 6 and classified, wherein the different classes of classification represent a specific state of the plasma arc method. Depending on the determined class, the evaluation unit 6 may output an electrical signal to the current source 4, which controls the electrical current accordingly. In further exemplary embodiments, a voltage source may also be used instead of the current source 4, which controls an electrical voltage accordingly.

In the exemplary embodiment shown in FIG. 1, the measured value recording device 5 is also configured to measure a voltage drop across the choke 7. The measured electrical voltage may be either the voltage between the electrode and the workpiece 1 or the voltage between the electrode and the nozzle and/or the aforementioned voltage drop across the choke 7. The measured electrical current may be the electrical current flowing from the electrode to the nozzle and/or the electrical current flowing from the electrode to the workpiece 1.

Typically, the evaluation unit 6 and the measured value recording unit 5 are configured as a single computing unit on which a computer program product may usually be run. The computer program product has software means which control the device shown in FIG. 1 or carry out the method described in greater detail below when the computer program product is run in this computing unit as an automation unit.

FIG. 2 shows a graph in which a typical curve of variables recorded by the measured value recording device 5, such as electrical voltage or electrical current, is shown over time in seconds. This graph shows the cutting current in amperes (top curve), the voltage between electrode and workpiece 1 in volts (middle curve) and the electrical voltage between electrode and nozzle in volts (bottom curve). In the range from 1.5 s there are increased fluctuations, and from 2.9 s there is a voltage dip. Any of these deviations indicate errors in the process and require the cutting process to be stopped quickly to protect the plasma torch. The fluctuations in the range at 0.7 s are caused by hafnium in the arc or double arcs between the cathode and nozzle, among other things. However, since a threshold value, which according to the prior art is intended to serve as a fault indicator, may be exceeded (and the process may be interrupted), particularly with the fluctuations at 0.7 s, and the process may then be continued as normal, pattern recognition is carried out in the method described in order to more reliably detect actual fault events that make it necessary to interrupt the plasma arc method.

FIG. 3 shows a schematic view of a corresponding pattern recognition process. In a step S3-1, the signal curve determined from the measured values by the measured value recording device 5 is stored and, if necessary, transferred to the evaluation unit 6. In step S3-2, at least one feature is determined from the signal curve (or, if the signal curves of several physical variables are present, from each of the signal curves or at least from at least two signal curves). In step S3-3, a pattern recognition is carried out via a similarity comparison in order to determine which known pattern or which state of the plasma arc method the present signal curve resembles.

Pattern recognition is understood here as the ability to recognize regularities, repetitions, similarities or uniformities in a set of data such as the measured values or the signal curve. The features defined for a pattern serve to distinguish it from the content of other classes. In addition to the detection of data by sensors (as already described above), pre-processing for data reduction may also be provided to improve data quality. By extracting the features as part of pattern recognition, the patterns are then transformed into a feature space during feature extraction. In the feature space, the patterns are represented as points, wherein the features may typically be represented mathematically as vectors, the so-called feature vectors. The features are measured as numerical values and combined into a (multidimensional) feature vector. If necessary, an intermediate step of feature reduction may be included in the method sequence in order to limit the samples to the essentials. A classification assigns a feature vector to be examined to a class that provides the greatest correspondence or similarity with the feature vector to be examined, i.e. the features of which provide the greatest correspondence or similarity with the feature vector to be examined. This may be done using a mathematical function, such as the scalar product between the feature vector to be analyzed and one or more vectors representing the respective class or a classifier that assigns the features to different classes and thus maps a process state. If, for example, a faulty state of a wearing part is detected in the subsequent step S3-4 (by classifying the sample into the corresponding class), the power source 4 may be switched off in step S3-5, for example.

During pre-processing, the signal may pass through a high-pass filter, a low-pass filter or a band-pass filter, for example. Alternatively or additionally, the measured values may also be normalized. The actual features may vary and include, for example, key figures of a distribution function, moments such as the expected value and the variance or correlation and convolution.

In addition, it is also possible to transfer the measured values into the frequency domain using a transformation such as a discrete Fourier transformation in order to obtain a more manageable feature space.

FIG. 4 also shows a detailed representation of the pattern recognition in a flow chart. After the start in step S4-1, a memory is created in step S4-2 in the measured value recording device 5 for a total of M samples as sampled values. The number of samples is at least 5000 for the selected exemplary embodiment and the time between the recording of two samples is a maximum of 0.1 ms. The entire measurement period may be a maximum of 1 s in the example shown.

In step S4-3, N samples of the voltage between the electrode and the nozzle are sampled and these samples are added to the memory (wherein N<M). Step S4-4 checks whether the memory is full, i.e. whether there are a total of M samples in the memory. If no, the cutting process is continued, if yes, the pattern recognition process is carried out in steps S4-6, S4-7 and S4-8.

For this purpose, in step S4-6 in the exemplary embodiment shown, the M samples are first pre-processed and the features are obtained from the signal curve in step S4-7. Step S4-8 checks whether a predefined classifier provides the closest match to a specific class, for example the class “cathode failure” or “wearing part failure”. If not, the N oldest samples are removed from the memory in step S4-5 and the process is continued. If so, the cutting process is ended in step S4-9 and the error message “wearing part failure”, for example, is output on a display unit before the end is reached in step S4-10. In the exemplary embodiment shown, “regular process sequence” (here the plasma arc method continues) and “irregular process sequence” (here the process also continues, but a warning message is issued to a user, for example with the fluctuations at 0.7 s shown in FIG. 2) may be defined as further classes.

In general, a “teaching phase” may also be provided, in which the evaluation unit 6 stores a database with several patterns and the associated classes or teaches them using a classification procedure. For example, an artificial neural network or a “support vector machine” may also be used here.

In FIG. 5, an electrical voltage is plotted against an electrical current to illustrate different classes. As a result of the classification, the signal curve is divided into a “new wearing parts” class, a “used wearing parts” class or a “worn wearing parts” class. Further classes may be made on the basis of the cathode burn-back in the range from 0 percent to 100 percent in relation to a maximum possible burn-back. FIGS. 6 and 7 show signal curves in which an electrical voltage in V is plotted against the time in s and exemplary signal curves for the class “defective wearing parts” (FIG. 6) and for the classes “driving off the plate” (solid line in FIG. 7) and “running over a joint” (dashed lines in FIG. 7) or “piercing process completed” (alternating dashed and dotted line in FIG. 7). For example, the classes “idling”, “ignition of a pilot arc”, “maintenance of the pilot arc”, “piercing of the workpiece”, “penetration through the workpiece”, “cutting of the workpiece” or “running over a workpiece edge” may also be defined and the features assigned accordingly.

FIG. 8 shows the result of a Fourier transformation of a signal curve obtained at a sampling rate of 50 kHz. In the frequency ranges shaded in gray, the amplitudes are added up (□1 and □2) and the sums are used as features for classification, i.e. a feature vector may be formed from the numbers obtained and assigned to a specific class. By using the Fourier transformation, the signal curve may be evaluated independently of the magnitude of the voltage amplitudes or similar and rates of change. FIG. 8 shows a signal curve of a regular cutting process (solid curve) and a signal curve of a defect in a wearing part (dashed curve). There are beats between 50 Hz and 100 Hz, which are caused by the current source 4 and are therefore ignored in the evaluation. The two sums formed correspond to two features and the resulting numerical values allow a clear distinction to be made. In the exemplary embodiment shown, the last 327 ms of the method were temporarily stored in a memory, resulting in 16384 samples, which may be reduced to just two key numbers for calculating the class assignment by determining the features in the amplitude spectrum. A “k nearest neighbor” classifier was used as the classifier in the embodiment shown. In further exemplary embodiments, however, a “linear support vector machine (linear SVM)”, “radial basis function support vector machine (RBF SVM)”, “Gaussian process”, “random forest”, “neural network”, “adaptive boosting”, “naive Bayes” or “quadratic discriminant analysis (QDA)” classifier or a calculation of a distance between the feature vectors associated with the classes and the feature vector to be examined may also be used, depending on the intended application. The class assignment for a feature combination is calculated by determining the k nearest objects classified from the teaching phase. A feature or object is assigned to the class that occurs most frequently among the k nearest neighbors.

FIG. 9 shows the parameterization of individual sub-regions. In the graphs (in the left graph for new wearing parts, in the right graph for wearing parts before the end of their service life) the electrical voltage between electrode and nozzle is plotted against the current and the ranges between 75 A and 150 A, 170 A and 250 A, and between 250 A and 300 A are used for a regression calculation. The coefficients a1, b1, c1, a2, b2, c2 and a3, b3, c3, d3, obtained by the regression calculation, may be used as features for classification. In general, however, the amplitude, a concave or convex curve and/or a rise may also be used as features.

FIG. 10 shows a schematic two-dimensional feature space in which two different features are plotted on the axes and a feature vector formed from these features is directed to a specific point in the feature space. To create the feature space shown in FIG. 10, the features (shown as dots in FIG. 10) are collected from a training data set and assigned to classes in a first step. By training a classifier, a function is obtained that automatically assigns a class to a new feature vector. The classifier thus assigns the class with the “highest” match to a feature combination, as shown by the two arrows. In the exemplary embodiment shown in FIG. 10, three classes are therefore formed. Lastly, FIG. 11 shows a real feature space in which the end points of the feature vectors are drawn. The three classes correspond to “destruction of wearing parts”, “regular cutting area” and “irregular process sequence”.

Features of the various embodiments disclosed only in the exemplary embodiments may be combined with each other and claimed individually.

1-14. (canceled)

15. A method for recognizing a process state of a plasma arc method, in which a workpiece is processed by a plasma torch and measured values of a time curve of a physical variable of the plasma arc method are detected and a signal curve is determined from the measured values, wherein a pattern recognition is performed on the signal curve by extracting at least one feature from the signal curve and classifying said feature, and the signal curve is assigned to a specific state of the plasma arc method according to the classification of the feature.

16. The method according to claim 15, characterized in that the physical variable is an electrical voltage, an electrical voltage drop and/or an electrical current.

17. The method according to claim 15, characterized in that the at least one feature is determined from amplitudes of the measured values and/or an amplitude spectrum.

18. The method according to claim 17, characterized in that the at least one feature is determined from a sum of the amplitude spectrum over at least one predetermined frequency range.

19. The method according to claim 15, characterized in that the at least one feature is determined from a parameterization of the signal curve.

20. The method according to claim 19, characterized in that the at least one feature is determined from a parameterization of individual portions of the signal curve by forming a sequence of mean values and/or change rates and/or regression values of a regression analysis.

21. The method according to claim 15, characterized in that at least two features are extracted from the signal curve and are classified.

22. The method according to claim 15, characterized in that the classes of the classification comprise at least one stable process state and at least one unstable process state.

23. The method according to claim 22, characterized in that, in the case of a classification into the stable process state, the plasma arc method is continued unchanged and is terminated in the event of a classification into the unstable process state of the plasma arc method.

24. The method according to claim 15, characterized in that the plasma arc method is plasma cutting and the following are used as classes: idling, ignition of a pilot arc, burning of the pilot arc, piercing of the workpiece, penetration through the workpiece, cutting of the workpiece, running over a cut, running over a workpiece edge, presence of a damaged wearing part, presence of a new wearing part, presence of a used wearing part and/or presence of a worn wearing part.

25. The method according to claim 24, characterized in that, on the basis of a cathode burn-back or on the basis of a maximum service life, the classes are divided into the following: presence of a damaged wearing part, presence of a new wearing part, presence of a used wearing part and/or presence of a worn wearing part.

26. A device for recognizing a process state of a plasma arc method, comprising a plasma torch for processing a workpiece, a measured value recording device for recording measured values of a time curve of a physical variable of the plasma arc method and for determining a signal curve from the measured values, an evaluation unit for performing a pattern recognition on the signal curve, which evaluation unit is configured to extract at least one feature from the signal curve and to classify said feature and to assign the signal curve to a specific state of the plasma arc method according to the classification of the feature.

27. The device according to claim 26, characterized by an inductive component, which is connected in series with the plasma torch, wherein the measured value recording device is configured to measure an electrical current or an electrical voltage drop as the physical variable.

28. A computer program product with a computer program, comprising controlling a device according to claim 26 when the computer program is run in an automation system according to a method comprising recognizing a process state of a plasma arc method, in which a workpiece is processed by a plasma torch and measured values of a time curve of a physical variable of the plasma arc method are detected and a signal curve is determined from the measured values, wherein a pattern recognition is performed on the signal curve by extracting at least one feature from the signal curve and classifying said feature, and the signal curve is assigned to a specific state of the plasma arc method according to the classification of the feature.

29. A computer program product with a computer program, comprising software means for carrying out a method according to claim 11 by controlling a device when the computer program is run in an automation system, the device recognizing a process state of a plasma arc method, comprising a plasma torch for processing a workpiece, a measured value recording device for recording measured values of a time curve of a physical variable of the plasma arc method and for determining a signal curve from the measured values, an evaluation unit for performing a pattern recognition on the signal curve, which evaluation unit is configured to extract at least one feature from the signal curve and to classify said feature and to assign the signal curve to a specific state of the plasma arc method according to the classification of the feature.
